(19) United States
(12) Patent Application Publication
(10) Pub. No.: US 2026/0034482 A1
(43) Pub. Date: Feb. 5, 2026

(54) Y-Strainers and Related Methods

(71) Applicant: Hayward Industries, Inc., Charlotte, NC (US)

(72) Inventors: Christopher Moncur, Pfafftown, NC (US); Benjamin Nowak, Clemmons, NC (US); Jon T. Stone, Clemmons, NC (US); Jonathan Tucker, Winston-Salem, NC (US)

(73) Assignee: Hayward Industries, Inc., Charlotte, NC (US)

(21) Appl. No.: 19/276,574

(22) Filed: Jul. 22, 2025

Related U.S. Application Data
(60) Provisional application No. 63/678,786, filed on Aug. 2, 2024.

(51) Int. Cl. B01D 29/35; B01D 29/60; B01D 35/02

(52) U.S. Cl. CPC B01D 29/35; B01D 29/606; B01D 35/02; B01D 2201/291; B01D 2201/347; B01D 2201/4084; B01D 2201/4092

(57) ABSTRACT

A Y-strainer operable to strain debris and/or particles from a fluid in a flowing system is disclosed. The Y-strainer includes a body, a nut, a retainer, a strainer, and a retainer seal positioned about the retainer. The body includes an inlet port, an outlet port, a central portion, and a barrel leg. The nut is removably fastened to the barrel leg, while the retainer is coupled to the nut and positioned within the barrel leg. The strainer is engaged with the retainer and positioned within the barrel leg. The barrel leg interconnects with the central portion at an angle, which can be an acute angle. The retainer, nut, strainer, and retainer seal can form a strainer insert subassembly that is removable from the barrel leg as a single unit. A method of assembling the foregoing Y-strainer is also provided.

### RELATED APPLICATIONS

This application claims the benefit of priority to U.S. Provisional Patent Application No. 63/678,786 filed on Aug. 2, 2024, which is incorporated herein by reference in its entirety.

### BACKGROUND

### Field of the Invention

The present disclosure relates to the field of flow control devices. More specifically, the present disclosure relates to an improved Y-strainer that prevents debris and particles from flowing through a piping system, and related methods.

### Related Art

Y-strainers are devices that are used in various commercial and industrial applications, and can be installed in piping systems to allow the forward flow of fluid in the system, e.g., from an inlet of the Y-strainer to an outlet of the Y-strainer, while capturing particles larger than a predetermined size and preventing the captured particles from flowing therethrough and into the piping system. Y-strainers are generally installed in piping systems where it is necessary to strain debris from a fluid in a flowing system, as fluid with larger particles could damage devices further downstream of the strainer in the system if not properly removed.

Y-strainers known in the art commonly include a body, a straining element, and end connections. The end connections can be internal or external to the body, are designed to transition the fluid between the Y-strainer and the piping system, and can use threads, socket and solvent cement, or flanges. Y-strainers are uni-directional devices that are generally designed to strain debris or particles from a fluid flowing through a piping system. The body generally includes three legs resembling a “Y” shape, including an inlet through which fluid enters the Y-strainer from an adjoined piping system, an outlet through which fluid exits the Y-strainer and reenters the adjoined piping system, and a barrel leg that houses the straining element. The barrel leg is positioned to allow fluid to easily pass through the Y-strainer from the inlet side, collect debris (e.g., debris that is larger than the strainer openings), and then exit through the outlet. Accordingly, once forward flow in the piping system is started, fluid passes from the inlet to the straining element in the barrel leg. The fluid is forced through a large opening into the straining element and then through the smaller openings of the straining element. Any particle larger than the strainer element openings are collected in the device and prevented from flowing downstream any further. When the flow is stopped in the piping system, the straining element can be removed from the barrel leg to remove the collected debris and clean the straining element. The debris collected in the strainer element of the Y-strainer can be removed/cleaned when the system is shut down.

Y-strainers can come in various designs, sizes, and materials. For example, thermoplastic Y-strainers are known in the art, and provide corrosion resistance and reduced weight compared to metal counterparts.

However, notwithstanding the foregoing, some prior art Y-strainer are known to have a small opening at the straining element entrance, thus causing a restriction in fluid flow and reducing flow through the Y-strainer device. This can impact flow through the piping system in which the Y-strainer is installed, as well as operation of the other components installed in the piping system. Additionally, prior art Y-strainer are known to require additional machining for some parts thereof in order to create sufficiently smooth surfaces that provide an adequate seal for proper operation when installed. This additional part machining can increase manufacturing time and costs. Furthermore, some prior art methods of assembling and disassembling the strainer component of prior art Y-strainers are known to be difficult and require extra care in order to assure that none of the parts are mishandled, damaged, or dropped during the process. This can increase manufacturing time and costs.

Moreover, some prior art Y-strainers can be disassembled for maintenance. However, if pressure is built up in the piping system and the Y-strainer barrel prior to disassembly, then the barrel cap can suddenly dislodge during disassembly in the direction of the technician performing the maintenance.

Accordingly, there is a need for Y-strainers that address the foregoing and other needs.

### SUMMARY

The present disclosure relates to a Y-strainer that prevents debris and particles from flowing through a piping system, and related methods.

In accordance with aspects of the present disclosure, a Y-strainer device for installation in a piping system is provided. The Y-strainer includes a body, a nut, a retainer, a strainer, and a retainer seal. The body includes an inlet port, an outlet port, a central portion extending between the inlet port and the outlet port, and a barrel leg. The central portion of the body defines a first chamber that places the inlet port in fluidic communication with the outlet port, while the barrel leg defines a second chamber that is in fluidic communication with the first chamber. The nut is removably fastened to a distal end of the barrel leg, while the retainer is coupled to the nut and positioned within the second chamber defined by the barrel leg. The strainer, which is configured to strain debris and particles from a fluid flowing through the body, is engaged with the retainer and positioned within the second chamber defined by the barrel leg. The retainer seal forms a seal between the retainer and the barrel leg when the retainer is positioned within the second chamber defined by the barrel leg. The barrel leg interconnects with the central portion at an angle.

In some aspects, the angle can be an acute angle.

In some aspects, at least a portion of the strainer can extend into the first chamber defined by the central portion. In other aspects, the body can include a fillet between the barrel leg and the outlet port or the barrel leg and the central portion.

In some other aspects, the barrel leg can include an open end in fluidic communication with the second chamber defined by the barrel leg and threads on an exterior of the open end. In such aspects, the nut can include interior threads that are configured to engage the threads on the exterior of the open end of the barrel leg. Additionally, the exterior threads of the barrel leg can be configured to expand into the interior threads of the nut when there is a surge of pressure in the barrel leg. For example, the exterior threads and the interior threads can be buttress threads.

In other aspects, the Y-strainer can include a retainer end cap connected to an end of the strainer, which can interconnect the strainer with the retainer such that the strainer is engaged with the retainer through the retainer end cap. In such aspects, the retainer end cap can be removably engaged with the retainer. For example, the retainer end cap can be removably engaged with the retainer with a snap-fit connection.

In some other aspects, the Y-strainer can include a first retainer end cap connected to a first end of the strainer and a second retainer end cap connected to a second end of the strainer. In such aspects, the first and second retainer end caps can be respectively connected to the first and second ends of the strainer by spin welding. In other such aspects, the first retainer end cap, the strainer, and the second retainer end cap can be molded as a single component. In still other such aspects, the first retainer end cap can be removably engaged with the retainer. For example, the first retainer end cap can be removably engaged with the retainer with a snap-fit connection.

In other aspects, the strainer can include a hollow cylindrical body and a plurality of flow openings that extend through the hollow cylindrical body. The plurality of flow openings can be formed by laser cutting and/or by a mechanical perforating machine.

In some other aspects, unfastening of the nut can cause the retainer, the strainer, and the retainer seal to be drawn out from the second chamber defined by the barrel leg, and a pressure relief passage to be formed.

In other aspects, unfastening of the nut can cause the seal between the retainer and the barrel leg formed by the retainer seal to be broken and a pressure relief passage to be formed. In such aspects, the retainer seal can be a piston seal or a face seal.

In still other aspects, the barrel leg can include a first bore, a second bore, and a chamfer between the first bore and the second bore, and the retainer seal can form a seal between the retainer and the second bore. In such aspects, unfastening of the nut can cause the retainer, the strainer, and the retainer seal to be drawn out from the second chamber defined by the barrel leg. Additionally, in such aspects, the retainer seal can traverse the chamfer when the nut is unfastened and the retainer, the strainer, and the retainer seal are drawn out from the second chamber defined by the barrel leg. Furthermore, a passage can be formed between the retainer seal and the first bore when the retainer seal traverses the chamfer. In such aspects, the passage can allow for pressure within the barrel leg to be relieved therethrough. Additionally, the nut can remain fastened to the distal end of the barrel as the retainer seal traverses the chamfer and the passage is formed.

In other aspects, the retainer seal can be a piston seal that can isolate the distal end of the barrel leg from pressure within the second chamber defined by the barrel leg.

In some other aspects, the nut, the retainer, the strainer, and the retainer seal can be removable from the barrel leg as a single unit.

Additionally, in some aspects, the retainer can include a counter-bore that defines an internal chamber that collects debris and particles strained by the strainer.

In other aspects, the retainer can include first and second annular shoulders defining an annular channel therebetween, the annular channel configured to receive a portion of the nut and permanently connect the nut and the retainer. In such aspects, the nut can include a top opening and a chamfered wall about the top opening. The nut and the retainer can be permanently connected by engaging the chamfered wall with the first annular shoulder of the retainer and forcing the first annular shoulder through the top opening causing the chamfered wall to snap over the first annular shoulder and into the annular channel. In such aspects, the nut can be capable of rotating freely about the retainer.

In some other aspects, the body can include a first tapped hole upstream of the strainer and a second tapped hole downstream of the strainer, the first and second tapped holes being configured to each receive a pressure sensing device to measure differential pressure across the strainer.

In still other aspects, the Y-strainer can include a mesh element positioned on an inside of the strainer. The mesh element can be configured to strain particles of smaller size than the particles strained by the plurality of flow openings.

In other aspects, the seal formed by the retainer seal can be between the retainer and an interior wall of the barrel leg.

In some aspects, the retainer seal can be a piston seal or a face seal.

In accordance with aspects of the present disclosure, a Y-strainer device for installation in a piping system is provided. The Y-strainer includes a body and a strainer insert subassembly. The body includes an inlet port, an outlet port, a central portion extending between the inlet port and the outlet port, and a barrel leg. The central portion of the body defines a first chamber that places the inlet port in fluidic communication with the outlet port, while the barrel leg defines a second chamber that is in fluidic communication with the first chamber. The strainer insert subassembly includes a retainer-nut subassembly and a strainer. The retainer-nut subassembly includes a nut removably fastened to a distal end of the barrel leg, a retainer coupled to the nut and removably positioned within the second chamber defined by the barrel leg, and a retainer seal. The retainer seal forms a seal between the retainer and the barrel leg when the retainer is removably positioned within the second chamber defined by the barrel leg. The strainer, which is configured to strain debris and particles from a fluid flowing through the body, is engaged with the retainer and removably positioned within the second chamber defined by the barrel leg. The strainer insert subassembly is removable from the barrel leg as a single unit.

In some aspects, unfastening of the nut can cause the retainer, the strainer, and the retainer seal to be drawn out from the second chamber defined by the barrel leg as a single unit. In other aspects, at least a portion of the strainer can extend into the first chamber defined by the central portion. In some other aspects, the body can include a fillet between the barrel leg and the outlet port or the barrel leg and the central portion.

In still other aspects, the barrel leg can include an open end in fluidic communication with the second chamber defined by the barrel leg and threads on an exterior of the open end. In such aspects, the nut can include interior threads that are configured to engage the threads on the exterior of the open end of the barrel leg. Additionally, the exterior threads of the barrel leg can be configured to expand into the interior threads of the nut when there is a surge of pressure in the barrel leg. For example, the exterior threads and the interior threads can be buttress threads.

In other aspects, the Y-strainer can include a retainer end cap connected to an end of the strainer, which can interconnect the strainer with the retainer such that the strainer is engaged with the retainer through the retainer end cap. In such aspects, the retainer end cap can be removably engaged with the retainer. For example, the retainer end cap can be removably engaged with the retainer with a snap-fit connection.

In some other aspects, the Y-strainer can include a first retainer end cap connected to a first end of the strainer and a second retainer end cap connected to a second end of the strainer such that the first retainer end cap, the strainer and the second retainer end cap can form a strainer subassembly that is removably connectable to the retainer-nut subassembly. In such aspects, the first and second retainer end caps can be respectively connected to the first and second ends of the strainer by spin welding. In other such aspects, the first retainer end cap, the strainer, and the second retainer end cap can be molded as a single component. In still other such aspects, the first retainer end cap can be removably engaged with the retainer. For example, the first retainer end cap can be removably engaged with the retainer with a snap-fit connection.

In other aspects, the strainer can include a hollow cylindrical body and a plurality of flow openings that extend through the hollow cylindrical body. The plurality of flow openings can be formed by laser cutting and/or by a mechanical perforating machine.

In some other aspects, unfastening of the nut can cause the retainer, the strainer, and the retainer seal to be drawn out from the second chamber defined by the barrel leg, and a pressure relief passage to be formed.

In other aspects, unfastening of the nut can cause the seal between the retainer and the barrel leg formed by the retainer seal to be broken and a pressure relief passage to be formed. In such aspects, the retainer seal can be a piston seal or a face seal.

In still other aspects, the barrel leg can include a first bore, a second bore, and a chamfer between the first bore and the second bore, and the retainer seal can form a seal between the retainer and the second bore. In such aspects, unfastening of the nut can cause the retainer, the strainer, and the retainer seal to be drawn out from the second chamber defined by the barrel leg. Additionally, in such aspects, the retainer seal can traverse the chamfer when the nut is unfastened and the retainer, the strainer, and the retainer seal are drawn out from the second chamber defined by the barrel leg. Furthermore, a passage can be formed between the retainer seal and the first bore when the retainer seal traverses the chamfer. In such aspects, the passage can allow for pressure within the barrel leg to be relieved therethrough. Additionally, the nut can remain fastened to the distal end of the barrel as the retainer seal traverses the chamfer and the passage is formed.

In other aspects, the retainer seal can be a piston seal that can isolate the distal end of the barrel leg from pressure within the second chamber defined by the barrel leg.

In some other aspects, the barrel leg can interconnect with the central portion at an acute angle.

Additionally, in some aspects, the retainer can include a counter-bore that defines an internal chamber that collects debris and particles strained by the strainer.

In other aspects, the retainer can include first and second annular shoulders defining an annular channel therebetween, the annular channel configured to receive a portion of the nut and permanently connect the nut and the retainer. In such aspects, the nut can include a top opening and a chamfered wall about the top opening. The nut and the retainer can be permanently connected by engaging the chamfered wall with the first annular shoulder of the retainer and forcing the first annular shoulder through the top opening causing the chamfered wall to snap over the first annular shoulder and into the annular channel. In such aspects, the nut can be capable of rotating freely about the retainer.

In some other aspects, the body can include a first tapped hole upstream of the strainer and a second tapped hole downstream of the strainer, the first and second tapped holes being configured to each receive a pressure sensing device to measure differential pressure across the strainer.

In still other aspects, the Y-strainer can include a mesh element positioned on an inside of the strainer. The mesh element can be configured to strain particles of smaller size than the particles strained by the plurality of flow openings.

In other aspects, the seal formed by the retainer seal can be formed between the retainer and an interior wall of the barrel leg.

In some other aspects, the retainer seal can be a piston seal or a face seal.

A method of assembling a Y-strainer device for installation in a piping system is provided. The method includes securing a nut to a retainer and thus forming a retainer-nut subassembly. The method further involves forming a strainer insert subassembly by securing a strainer, which is configured to strain debris and particles from a fluid flowing therethrough, to the retainer-nut subassembly. The method also involves inserting at least a portion of the strainer insert subassembly, including the strainer, through an opening in a barrel leg of a body and into a first chamber defined by the barrel leg. The first chamber is in fluidic communication with a second chamber that is defined by a central portion of the body extending between an inlet port and an outlet port, and places the inlet port in fluidic communication with the outlet port. The barrel leg interconnects with the central portion of the body at an angle, which, in some aspects, can be an acute angle. The method also involves coupling the nut to the barrel leg, which removably secures the retainer-nut subassembly to the body with the portion of the strainer insert subassembly inserted through the opening positioned within the first chamber, and forming a seal between the retainer and the barrel leg with a retainer seal.

In some aspects, the method can involve inserting a first end of a strainer into a first retainer end cap and inserting a second end of the strainer into a second retainer end cap, thus forming a strainer subassembly between the first retainer end cap, the strainer, and the second retainer end cap. The method can further involve securing the first retainer end cap to the retainer, thus forming the strainer insert subassembly. In such aspects, the method can also involve affixing the first retainer end cap to the first end of the strainer and affixing the second retainer end cap to the second end of the strainer. In other such aspects, the action of securing the first retainer end cap of the strainer subassembly to the retainer of the retainer-nut subassembly can include removably securing the first retainer end cap of the strainer subassembly to the retainer of the retainer-nut subassembly with a snap-fit connection.

In other aspects, the method can involve unfastening the nut from the barrel leg to thereby cause the portion of the strainer insert subassembly positioned within the first chamber to be drawn out from the first chamber defined by the barrel leg, and a pressure relief passage to be formed,

In still other aspects, the method can involve unfastening the nut from the barrel leg to thereby cause the seal between the retainer and the barrel leg to be broken and a pressure relief passage to be formed. In such aspects, the retainer seal can be a piston seal or a face seal.

In some other aspects, the portion of the strainer insert subassembly inserted through the opening and positioned within the first chamber can include the strainer, the retainer seal, and at least a portion of the retainer, and the seal formed by the retainer seal can be formed between the retainer and an interior wall of the barrel leg. In such aspects, the barrel leg can include a first bore, a second bore, and a chamfer between the first bore and the second bore, and the seal can be formed between the retainer and the second bore. Such aspects can also involve unfastening the nut from the barrel leg, which can cause the retainer, the strainer, and the retainer seal to be drawn out from the first chamber defined by the barrel leg. In such aspects, the method can also involve causing the retainer seal to traverse the chamfer as the nut is unfastened from the barrel leg, forming a passage between the retainer seal and the first bore as the retainer traverses the chamfer, and relieving pressure built-up in the barrel leg through the passage. In some such aspects, the nut can remain fastened to the barrel leg when the passage is formed and the pressure is relieved. In some other such aspects, the method can involve removing the nut, the retainer, the strainer, and the retainer seal from the barrel leg as a single unit.

In some aspects, the method can involve isolating a distal end of the barrel leg from pressure within the first chamber defined by the barrel leg with the retainer seal, which can be a piston seal.

In some other aspects, the method can involve engaging a first annular shoulder of the retainer with a chamfered wall of the nut, which can surround a top opening of the nut, and forcing the first annular shoulder through the top opening, thus causing the chamfered wall to snap over the first annular shoulder and into an annular channel of the retainer, which can be defined by the first annular shoulder and a second annular shoulder. In such aspects, the nut can be capable of rotating freely about the retainer.

In still other aspects, the method can involve installing the Y-strainer in a piping system, flowing fluid through a plurality of flow openings extending through a hollow cylindrical body of the strainer, and straining debris and particles from the fluid and collecting the debris and particles in the hollow cylindrical body. Such aspects can also involve collecting debris and particles in an internal chamber of the retainer.

In other aspects, fastening the nut to the barrel leg can include engaging interior threads of the nut with exterior threads of the barrel leg, and the exterior threads of the barrel leg can be configured to expand into the interior threads of the nut when there is a surge of pressure in the barrel leg. In such aspects, the exterior threads and the interior threads can be buttress threads.

In some other aspects, the method can involve forming a first tapped hole in the body upstream of the strainer, forming a second tapped hole in the body downstream of the strainer, engaging a first pressure sensing device with the first tapped hole, and engaging a second pressure sensing device with the second tapped hole. In such aspects, the first and second pressure sensing devices can allow a differential pressure across the barrel leg to be measured.

In still other aspects, the body can include a fillet between the barrel leg and the outlet port or the barrel leg and the central portion.

In other aspects, the retainer can be a piston seal or a face seal.

Other features will become apparent from the following detailed description considered in conjunction with the accompanying drawings. It is to be understood, however, that the drawings are designed as an illustration only and not as a definition of the limits of the invention.

### BRIEF DESCRIPTION OF THE DRAWINGS

The foregoing features of the invention will be apparent from the following Detailed Description, taken in connection with the accompanying drawings, in which:

FIG. 1 is a top perspective view of an exemplary Y-strainer of the present disclosure;

FIG. 2 is a side view of the exemplary Y-strainer of FIG. 1;

FIG. 3 is a top plan view of the exemplary Y-strainer of FIG. 1;

FIG. 4 is an exploded view of the exemplary Y-strainer of FIG. 1;

FIG. 5A is a perspective view of a body of the exemplary Y-strainer of FIG. 1;

FIG. 5B is a sectional view of the body of FIG. 5A taken along line 5B-5B of FIG. 5A;

FIG. 6 is a side perspective view of a first alternative body according to the present disclosure;

FIG. 7 is a side perspective view of a second alternative body according to the present disclosure;

FIG. 8A is a perspective view of a retainer of the exemplary Y-strainer of FIG. 1;

FIG. 8B is a front view of the retainer of FIG. 8A;

FIG. 8C is a side view of the retainer of FIG. 8A;

FIG. 8D is a sectional view of the retainer of FIG. 8A taken along line 8D-8D of FIG. 8C;

FIG. 9A is a perspective view of a barrel nut of the exemplary Y-strainer of FIG. 1;

FIG. 9B is a side view of the barrel nut of FIG. 9A;

FIG. 9C is a top view of the barrel nut of FIG. 9A;

FIG. 9D is a sectional view of the barrel nut of FIG. 9A taken along line 9D-9D of FIG. 9C;

FIG. 10A is a perspective view of a retainer-barrel nut subassembly of the exemplary Y-strainer of FIG. 1;

FIG. 10B is a side view of the retainer-barrel nut subassembly of FIG. 10A;

FIG. 10C is a sectional view of the retainer-barrel nut subassembly of FIG. 10A taken along line 10C-10C of FIG. 10B;

FIG. 11A is a top perspective view of a retainer end cap of the exemplary Y-strainer of FIG. 1;

FIG. 11B is a bottom perspective view of the retainer end cap of FIG. 11A;

FIG. 11C is a top view of the retainer end cap of FIG. 11A;

FIG. 11D is a side view of the retainer end cap of FIG. 11A;

FIG. 11E is a sectional view of the retainer end cap of FIG. 11A taken along line 11E-11E of FIG. 11C;

FIG. 12 is a perspective view of a strainer of the exemplary Y-strainer of FIG. 1;

FIG. 13A is a side view of a strainer subassembly of the exemplary Y-strainer of FIG. 1;

FIG. 13B is a side-perspective view of the strainer subassembly of FIG. 13A;

FIG. 14A is a perspective view of a strainer insert subassembly of the exemplary Y-strainer of FIG. 1;

FIG. 14B is a side view of the strainer insert subassembly of FIG. 14A;

FIG. 14C is a sectional view of the strainer insert subassembly of FIG. 14A taken along line 14C-14C of FIG. 14B;

FIG. 14D is the sectional view of FIG. 14C illustrating an alternative means of connecting components of the strainer insert subassembly;

FIG. 15 is a sectional view of the exemplary Y-strainer of FIGS. 1-4 taken along line 15-15 of FIG. 3; and

FIG. 16 is a sectional view of the exemplary Y-strainer of FIGS. 1-4 taken along line 15-15 of FIG. 3 showing the removal of components from the body thereof and the formation of a pressure relief passage.

### DETAILED DESCRIPTION

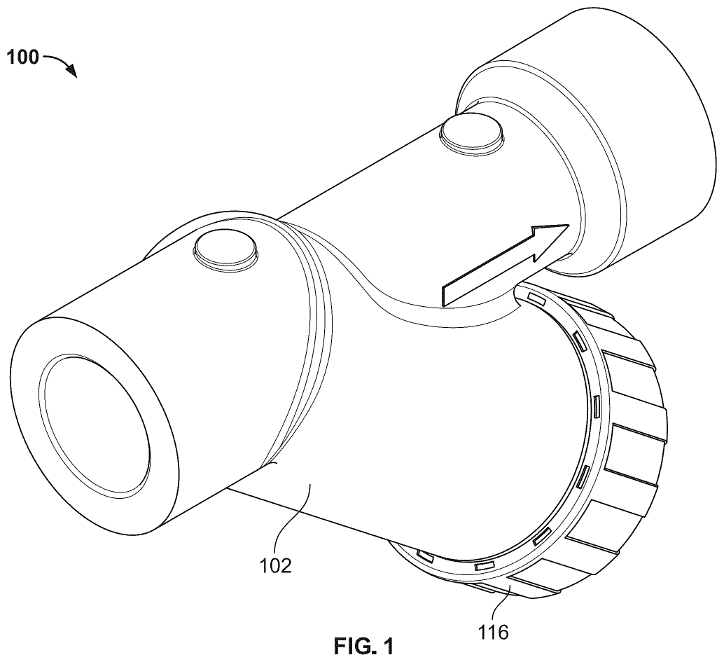

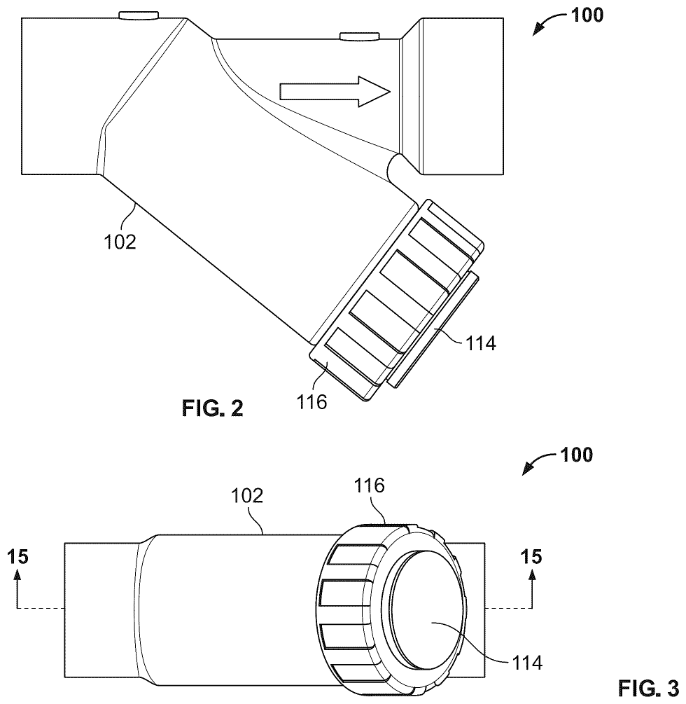

The present disclosure relates to Y-strainers and related components and methods, as discussed in detail below in connection with FIGS. 1-16.

It should be understood that the relative terminology used herein, such as “front,” “rear,” “left,” “top,” “bottom,” “vertical,” and “horizontal” is solely for the purposes of clarity and designation and is not intended to limit the invention to embodiments having a particular position and/or orientation. Accordingly, such relative terminology should not be construed to limit the scope of the present invention. In addition, it should be understood that the invention is not limited to embodiments having specific dimensions. Thus, any dimensions provided herein are merely for an exemplary purpose and are not intended to limit the invention to embodiments having particular dimensions.

FIGS. 1-4 are, respectively, top perspective, side, top, and exploded views of an exemplary Y-strainer 100 of the present disclosure. The Y-strainer 100 can be utilized in fluid systems to permit fluid to flow in a forward direction while straining debris and particles from flowing into a piping system and related components. That is, the Y-strainer 100 can be utilized to strain debris in a fluid system.

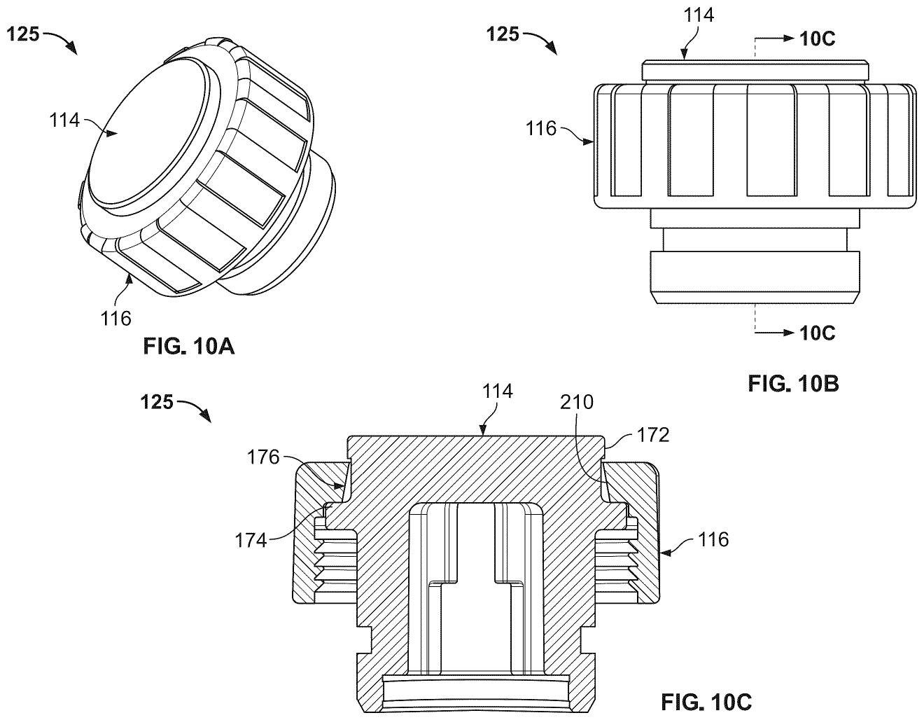

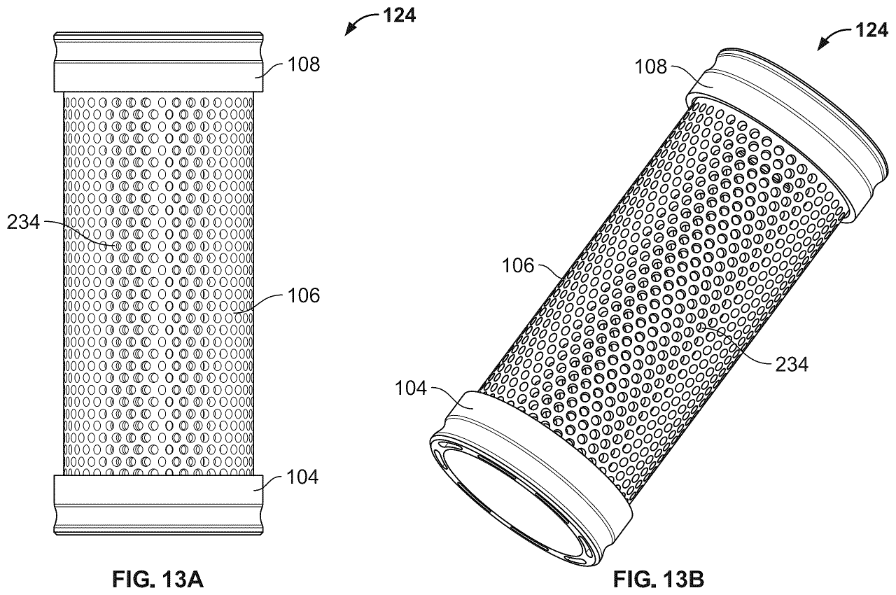

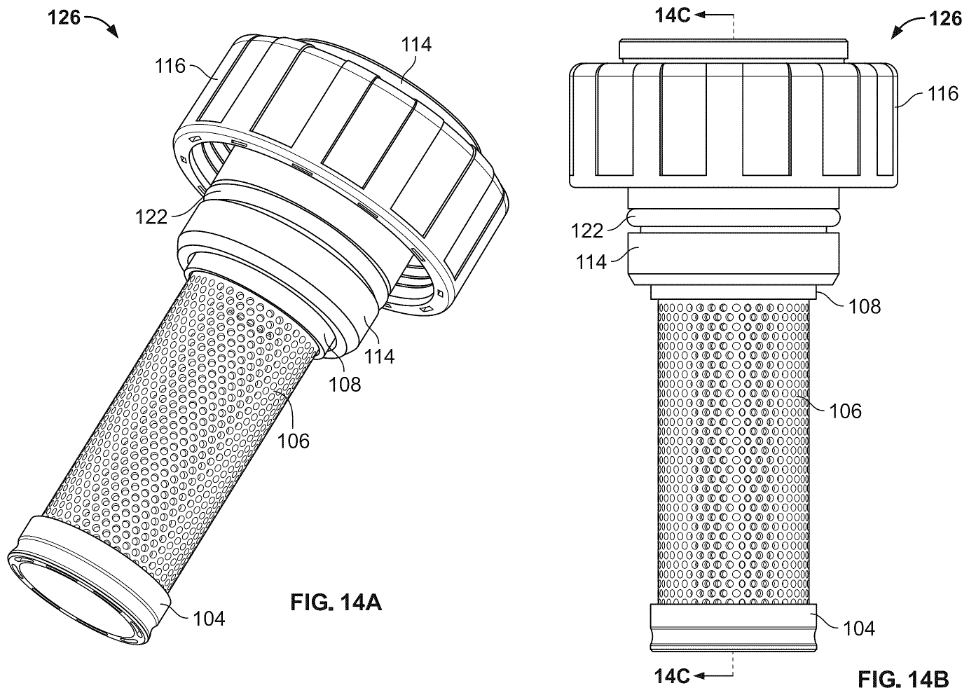

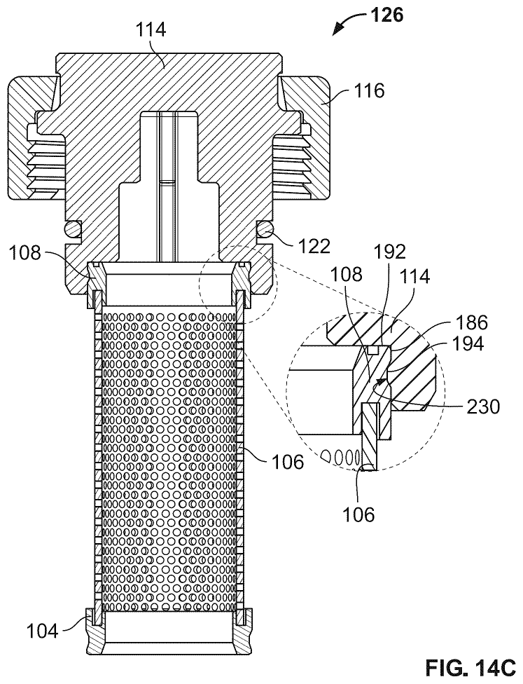

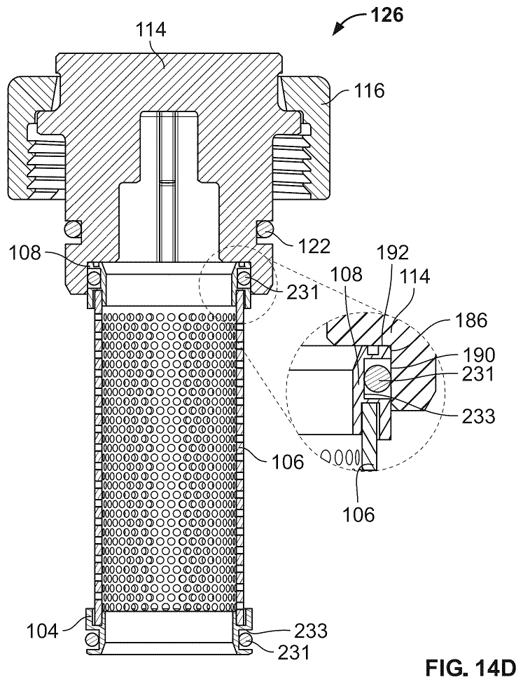

The exemplary Y-strainer 100 includes a body 102, two retainer end caps 104, 108, a strainer 106, a retainer 114, a barrel nut 116, and a retainer seal 122. The two retainer end caps 104, 108 and strainer 106 can form a strainer subassembly 124, which is shown and described in greater detail in connection with FIGS. 13A and 13B. The retainer 114 and barrel nut 116 can form a retainer-barrel nut subassembly 125, which is shown and described in greater detail in connection with FIGS. 10A-10C. Additionally, the two retainer end caps 104, 108, strainer 106, retainer 114, barrel nut 116, and seal 122 can form a strainer insert subassembly 126, which is shown and described in greater detail in connection with FIGS. 14A-C. In this regard, the two retainer end caps 104, 108, strainer 106, retainer 114, barrel nut 116, and seal 122 can be aligned along axis A₁.

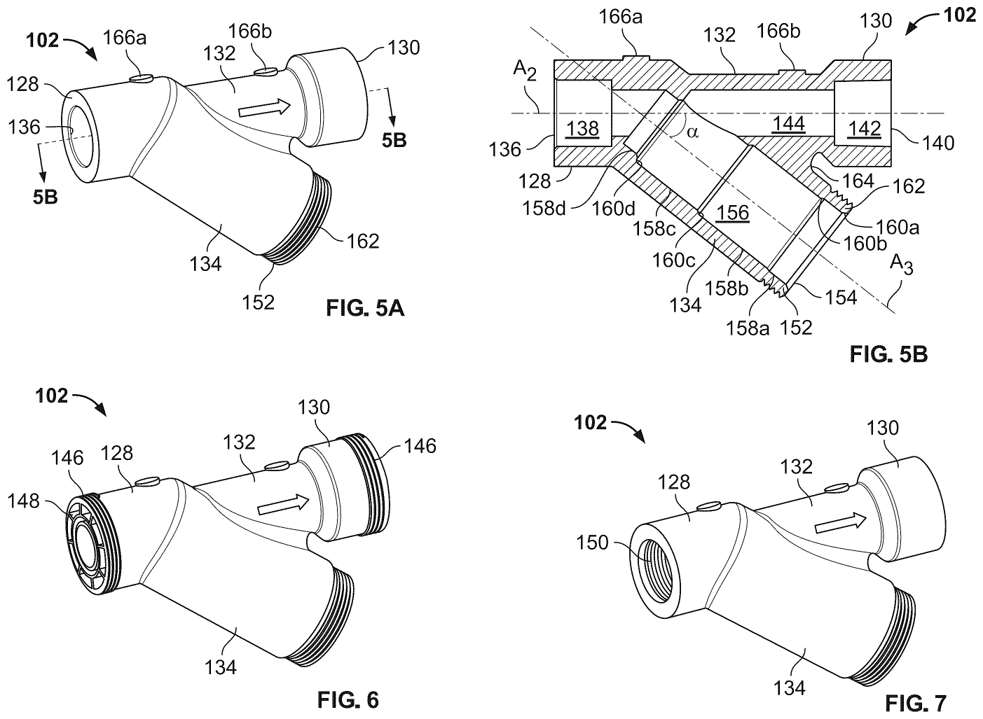

FIGS. 5A and 5B are perspective and sectional views of the body 102, respectively. The body 102 is the primary structural component of the Y-strainer 100 and includes an inlet port 128, an outlet port 130, a central portion 132, and a barrel leg 134. The inlet port 128 can be generally tubular in shape and defines an inlet opening 136 and an inlet flow chamber 138 while the outlet port 130 can also be generally tubular in shape and defines an outlet opening 140 and an outlet flow chamber 142. The central portion 132 extends between the inlet port 128 and the outlet port 130, and defines a central flow chamber 144 that is in fluidic communication with the inlet flow chamber 138 and the outlet flow chamber 142. The inlet flow chamber 138, central flow chamber 144, and outlet flow chamber 142 can be coaxial with each other along axis A₂. Accordingly, the inlet flow chamber 138, central flow chamber 144, and outlet flow chamber 142 together form a passage for fluid to flow through the body 102.

In this regard, the body 102 can be installed in a piping system in the same direction/orientation as an inlet-side pipe of the piping system, such that the inlet port 128 is connectable to the inlet-side pipe while the outlet port 130 is connectable to an outlet-side pipe of the piping system. Thus, the inlet port 128 is configured to accept the flow of fluid from the piping system while the outlet port 130 is configured to discharge fluid into the piping system. Accordingly, fluid can flow into the body 102 through the inlet opening 136, through the inlet flow chamber 138, through the central flow chamber 144, through the outlet flow chamber 142, and exit through the outlet opening 140.

The inlet and outlet ports 128, 130 can be designed and manufactured to accommodate different end connections that will transition flow from the piping system when installed. For example, as shown in FIGS. 5A and 5B, the inlet and outlet ports 128, 130 can be provided as internal socket end connections such that the inlet opening 136 and the outlet opening 130 are of sufficient size to accept a pipe of the piping system therein, which can be cemented in place. Thus, the inlet flow chamber 138 and the outlet flow chamber 142 can have a larger diameter than the central flow chamber 144. Alternatively, as shown in FIG. 6, the exterior surface of the inlet and outlet ports 128, 130 can have external threading 146 that is configured to accept true union end connections, e.g., the external threading 146 is configured to be engaged by a threaded nut (not shown), and a front face 148 of each of the inlet and outlet ports 128, 130 can be configured to engage an end connector (not shown) with an o-ring or other gasket positioned therebetween in an annular channel of the front face 148. Thus, the inlet and outlet ports 128, 130 of the alternative body 102 shown in FIG. 6 can be secured to end connectors by way of threaded nuts that are positioned over the end connectors and engage the external threading 146 of the inlet and outlet ports 128, 130. As another alternative, as shown in FIG. 7, the interior surface of the inlet and outlet ports 128, 130 can have internal threading 150, which can be engaged by an externally threaded pipe in order to secure the pipe to the body 102. It should be understood that the present application should not be limited to the foregoing end connections, and other end connections known in the art can be applied to the body 102 and thus fall within the scope of the present disclosure. Additionally, different sized end connections, e.g., the inlet and outlet ports 128, 130, can be provided depending on the piping system in which the Y-strainer 100 is being installed.

The barrel leg 134 is a generally cylindrical component that houses the working strainer components, e.g., the two retainer end caps 108, 104, strainer 106, retainer 114, and seal 122, allows for sealing of the Y-strainer 100 once assembled, and provides access to the working strainer components for maintenance and replacement. The barrel leg 134 has a central axis A₃ and interconnects with the central portion 132 of the body 102 at an angle with respect to the inlet and outlet ports 128, 130 to decrease any interrupted flow of the system as fluid passes through the Y-strainer 100. In particular, the barrel leg 134 interconnects to the remainder of the body 102 at an angle a, which is the angle between the axis A₂ of the inlet port 128, central portion 132, and outlet port 130 and the central axis A₃ of the barrel leg 134. The angle α of the barrel leg 134 is approximately 38°, which is less than, e.g., more acute than, prior art Y-strainers and increases the flow capacity of the Y-strainer 100 compared to prior art Y-strainers. However, angle α can be any angle between 0° and 90°, e.g., any acute angle, as desired. The angle at which the barrel leg 134 interconnects with the central portion 132 of the body 102 allows for a majority of the flow to pass straight through the strainer, allowing for improved debris/particle filtration. Additionally, an internal diameter of the barrel leg 134 can be increased to allow for increased flow.

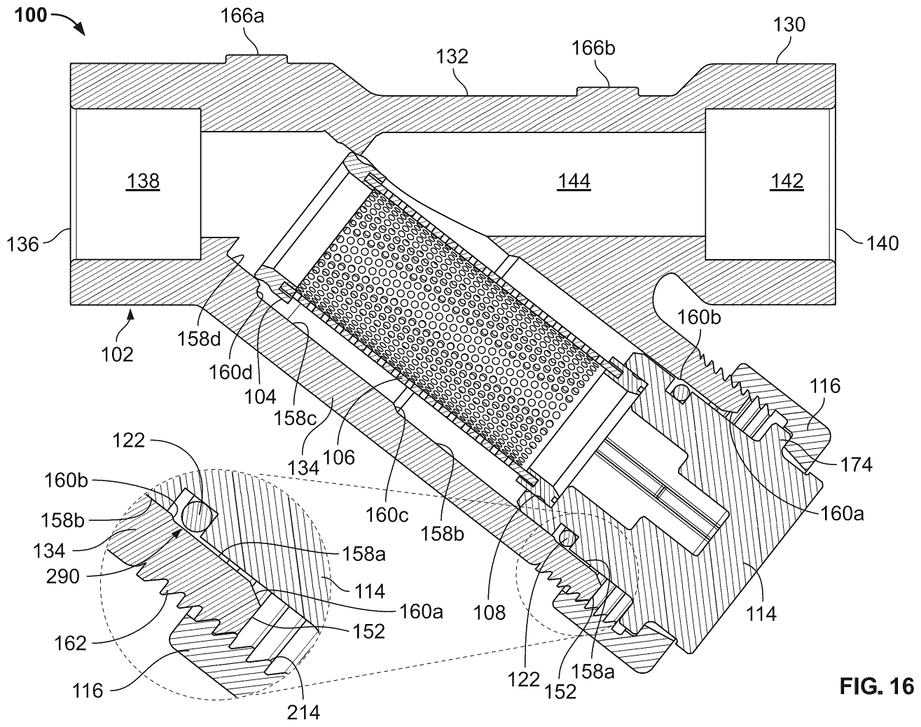

The barrel leg 134 includes an open end 152 defining an opening 154 in fluidic communication with a central chamber 156 that is defined by a series of four internal bores 158a-d of decreasing diameter. The open end 152 includes a first chamfer 160a, which accepts and assists with insertion of the working strainer components, e.g., the retainer 114, during the strainer assembly process. The barrel leg 134 additionally includes a second chamfer 160b between the first and second bores 158a, 158b, and can include a third chamfer 160c between the second and third bores 158b, 158c and a fourth chamfer 160d between the third and fourth bores 158c, 158d. The second chamfer 160b is designed to relieve pressure when disassembling the Y-strainer 100, which is shown and discussed in greater detail below in connection with FIG. 16. The central chamber 156 of the barrel leg 134 is generally larger in diameter than that of prior art Y-strainers to allow for increased flow. However, it should be understood that the diameter of the central chamber 156 can be designed according to the installation and piping system needs. The central chamber 156 intersects and is in fluidic communication with the central flow chamber 144. In particular, the central chamber 156 of the barrel leg 134 can extend into the central flow chamber 144 so that fluid can flow straight through the central chamber 156 when flowing through the Y-strainer 100.

The open end 152 of the barrel leg 134 includes external threads 162 that are configured to engage internal threads of the barrel nut 116 to assemble the Y-strainer 100 and secure the working strainer components, e.g., the two retainer end caps 104, 108, strainer 106, retainer 114, and seal 122, within the barrel leg 134. Since the external threads 162 are positioned on the exterior of the open end 152, as opposed to the interior, the external threads 162 will expand into the barrel nut 116 when there is a surge in pressure inside the body 102, thus creating a tighter seal and preventing the sudden disassembly and ejection of the internal working strainer components from the open end 152 of the barrel leg 134. The external threads 162 can be, for example, buttress threads configured to provide additional axial strength.

The body 102 additionally includes a fillet 164 on the outside of the acute angle between the barrel leg 134 and the outlet portion 130 or central portion 132, which is a known weak point in y-body designs. Accordingly, the fillet 164 provides additional structural strength by reducing the stress concentration at that location.

The body 102 also includes first and second bosses 166a, 166b on the exterior of the inlet port 128 and the central portion 132, respectively. Accordingly, the first bosses 166a, 166b are positioned on opposite sides of the barrel leg 134. The first and second bosses 166a, 166b can be drilled through or tapped, thus permitting the addition of a threaded port, e.g., a ¼″ NPT thread port, and a pressure sensing device, e.g., a pressure gauge, a pressure transducer, a manometer, etc., a flow sensing device, a valve, or other device, can be installed in the resulting hole/port of each boss 166a, 166b, if desired. Thus, a first pressure sensing device can be installed within the first boss 166a to measure the pressure within the inlet flow chamber 138 upstream of the barrel leg 134 (and the strainer components installed in the barrel leg 134) and a second pressure sensing device can be installed within the second boss 166b to measure the pressure within the central flow chamber 144 or the outlet flow chamber 142 downstream of the barrel leg 134 (and the strainer components installed in the barrel leg 134). Accordingly, the first and second pressure sensing devices can be used to measure differential pressure across the Y-strainer 100. It should be understood that other gauges, sensors, etc., can be installed in the first and second bosses 166a, 166b in place of the first and second pressure sensing devices.

The body 102 can be fabricated from a thermoplastic, for example, polyvinyl chloride (PVC), chlorinated polyvinyl chloride (CPVC), polyethylene (PE), polyvinylidene fluoride (PVDF), polypropylene (PP), and the like, using an injection molding process.

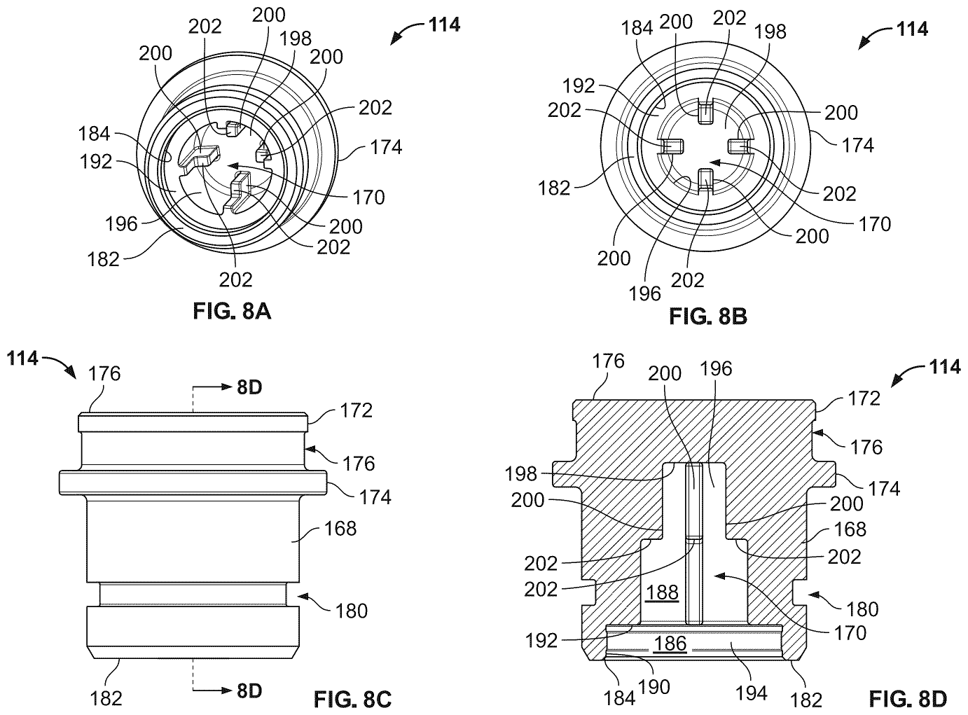

With reference to FIGS. 8A-8D, the retainer 114 includes a generally cylindrical unitary body 168 that defines an internal chamber 170. The retainer 114 includes first and second annular shoulders 172, 174 defining an annular channel 176 there between, which is configured to receive a portion of the barrel nut 116, as discussed in connection with FIGS. 10A-10C. The first annular shoulder 172 can include a chamfered upper edge 176, which facilitates insertion of the first annular shoulder 172 into the barrel nut 116 and forcing of the barrel nut 116 over the first annular shoulder 172. The second annular shoulder 174 is configured to rest on the open end 152 of the barrel leg 134 of the body 102 when the retainer 114 is inserted into the barrel leg 134. The retainer 114 additionally includes a circumferential channel 180 that extends into the exterior of the body 168. The circumferential channel 180 is configured to receive and house the retainer seal 122, which can be an o-ring or other gasket. The retainer seal 122 is generally compressed within the circumferential channel 180 between the body 168 of the retainer 114 and the inner surface of the second bore 158b of the barrel leg 134 when the retainer 114 is inserted into the barrel leg 134, and isolates the distal end of the barrel leg 134, e.g., the open end 152, from pressure within the barrel leg 134.

The retainer 114 includes an open end 182 defining an opening 184 in communication with the internal chamber 170. The internal chamber 170 is defined by a first bore 186 and a counter-bore 188. The first bore 186 is positioned immediately adjacent the opening 184 and is defined by a first inner cylindrical wall 190 and an internal radial shoulder 192. The first inner cylindrical wall 190 includes an annular ridge 194 extending radially inward therefrom, e.g., into the internal chamber 170. The annular ridge 194 is designed to removably engage the retainer end cap 108 and secure the strainer subassembly 124 to the retainer 114 by way of a snap-fit connection, which is discussed in greater detail in connection with FIGS. 14A-14C. The internal radial shoulder 192 is configured to prevent further insertion of the second retainer end cap 108 into the internal chamber 170 of the retainer 114 and thus ensures proper placement thereof.

The counter-bore 188 has a smaller diameter than the first bore 186 and is defined by a second inner cylindrical wall 196 and an end wall 198. The counter-bore 188 provides additional space for debris and particles to gather in as it is strained from fluid passing through the strainer 106, thus allowing a plurality of flow openings 234 in the strainer 106, described below, to remain open and maintain unobstructed flow through the strainer 106. The retainer 114 includes a plurality of internal stepped ribs 200 that extend radially inward from the second inner cylindrical wall 196 and into the counter-bore 188. The stepped ribs 200 span the length of the counter-bore 188, e.g., from the internal radial shoulder 192 to the end wall 198, and each include an intermediate shoulder 202.

It is additionally noted that the end wall 198 can be of sufficient thickness to allow for full tapping thereof thus permitting the addition of a threaded port, e.g., a ¼″ NPT thread port. Accordingly, a user can add a threaded port, e.g., a ¼″ NPT thread port, through the end wall 198 and install a blowout port (e.g., pressure relief port) or a pressure sensing device, e.g., a pressure gauge, a pressure transducer, a manometer, etc., therein.

Accordingly, the retainer 114 functions to accept the retainer seal 122, provide a sealing surface for the retainer seal 122, properly locate the retainer seal 122 on the inner surface of the second bore 158b of the barrel leg 134 when inserted into the barrel leg 134, provide additional space for the collection of debris, and provide functional structure to retain the strainer subassembly 124.

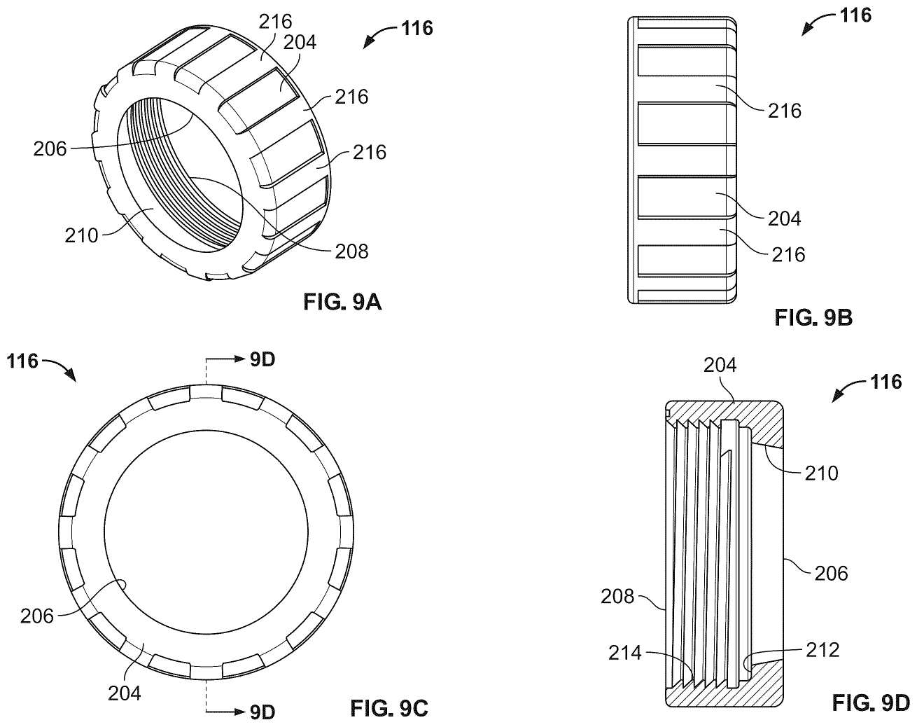

The barrel nut 116, which is shown in greater detail in FIGS. 9A-9D, includes an annular body 204 having a top opening 206 and a bottom opening 208. The top opening 206 is formed by a bore having an internal chamfered wall 210 that extends from the top opening 206 to an internal shoulder 212. The chamfered wall 210 angles radially outward from the top opening 206 to the internal shoulder 212 creating a cam surface. The top opening 206 and chamfered wall 210 allow the barrel nut 116 to be pressed onto the retainer 114 and permanently secured thereto, as shown in FIGS. 10A-10B, which illustrate the retainer-barrel nut subassembly 125. In particular, the barrel nut 116 can be placed over the retainer 114 such that the chamfered wall 210 surrounds and engages the first annular shoulder 172 of the retainer 114. Pressure can be applied to the barrel nut 116 and the retainer 114 to cause the first annular shoulder 172 to continue to progress along the chamfered wall 210, which acts as a cam ramp, and towards the top opening 206 until the chamfered wall 210 snaps over the first annular shoulder 172 and into annular channel 176 of the retainer 114. The second annular shoulder 174 of the retainer 114 engages the internal shoulder 212 of the barrel nut 116 and prevents the retainer 114 from being pulled through the top opening 206 of the barrel nut 116, while the first annular shoulder 172 prevents the barrel nut 116 from being disconnected from the retainer 114. Accordingly, the chamfered wall 210 is retained in the annular channel 176 and the barrel nut 116 is permanently attached to the retainer 114. When the barrel nut 116 is attached to the retainer 114, and the retainer-barrel nut subassembly 125 is formed, the chamfered wall 210 is permitted to rotate freely within the annular channel 176 such that the barrel nut 116 can rotate freely about the retainer 114.

The barrel nut 116 additionally includes internal threads 214 that are configured to engage the external threads 162 of the barrel leg 134 to assemble the Y-strainer 100 and secure the working strainer components, e.g., the two retainer end caps 104, 108, strainer 106, retainer 114, and seal 122, within the barrel leg 134. As previously noted, when there is a surge in pressure in the body 102, the external threads 162 of the barrel leg 134 can expand into the internal threads 214 of the barrel nut 116, thus creating a tighter seal and preventing the sudden disassembly and ejection of the internal working strainer components from the open end 152 of the barrel leg 134. The internal threads 214 can be, for example, buttress threads configured to provide additional axial strength. Additionally, the exterior surface of the barrel nut 116 can include ribs 216 that provide added strength and a better grip surface for assembly and maintenance.

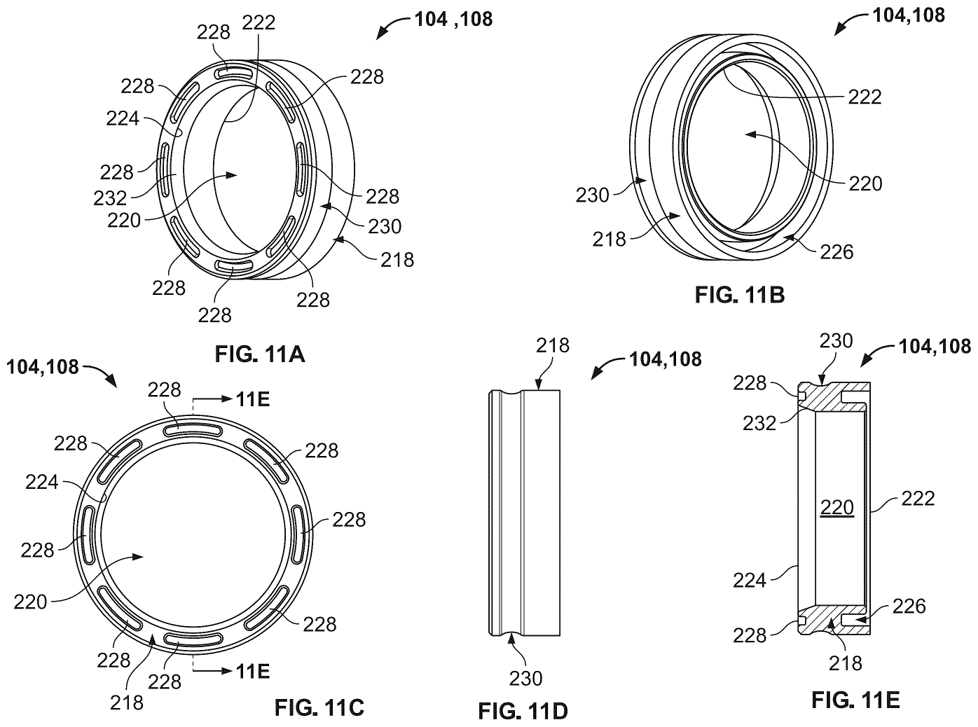

With reference to FIGS. 11A-11E, the retainer end caps 104, 108 include an annular body 218 defining a central cavity 220 that extends between a first opening 222 and a second opening 224. The annular body 218 includes an annular pocket 226 that is disposed in a bottom surface of the annular body 218 surrounding the first opening 222. The annular pocket 226 receives a portion of the strainer 106, which is discussed in connection with FIGS. 13A and 13B. The annular body 218 also includes a plurality of radially spaced pockets 228 that are disposed in a top flat surface of the retainer end cap 104, 108 and radially spaced about the second opening 224. The plurality of pockets 228 allow for tools to spin weld the retainer end cap 108 to the strainer 106 when the strainer 106 is inserted into the annular pocket 226. The plurality of pockets 228 allow for an improved welding connection. The annular body 218 of the retainer end cap 104, 108 includes an exterior circumferential indentation 230, which is configured to receive and engage the annular ridge 194 of the retainer 114 to removably secure the strainer subassembly 124 to the retainer 114 by way of a snap-fit connection.

Accordingly, the second retainer end cap 108 is configured to snap into and out of engagement with the retainer 114 using the exterior circumferential indentation 230 for assembly and maintenance with ease and without tools. It is additionally noted that the second retainer end cap 108 and the retainer 114 can be connected by other means, such as via threads, a twist lock connection, a lug and groove connection, a pressure-fit connection, or other mechanical engagement means. For example, the exterior circumferential indentation 230 of the retainer end caps 104, 108 can be sized and shaped such that it can receive a gasket 231 (see FIG. 14D), e.g., the exterior circumferential indentation 230 can be provided as an exterior circumferential channel 233 (see FIG. 14D) similar to the circumferential channel 180 of the retainer 114. In this configuration, the second retainer end cap 108 could sealingly engage the retainer 114 and be secured thereto with a pressure-fit arrangement, e.g., with a gasket 231 positioned within the exterior circumferential channel 233 and compressed between the first inner cylindrical wall 190 of the retainer 114 and the second retainer end cap 108, as shown in FIG. 14D, and the first retainer end cap 104 could sealingly engage the fourth bore 158d of the barrel leg 134, e.g., with a gasket positioned within the exterior circumferential indentation 230 and compressed between the fourth bore 158d and the first retainer end cap 104. Additionally, the first retainer end cap 104 can be configured to snap-fit into and out of engagement with the retainer 114, such that the strainer subassembly 124 is reversible. The annular body 218 can also include an internal chamfer 232 adjacent the second opening 224.

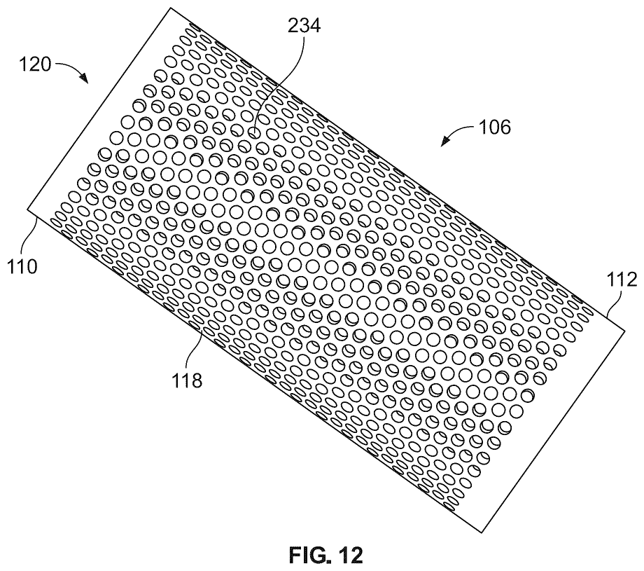

The strainer 106 is shown in greater detail in FIG. 12. The strainer 106 includes a hollow cylindrical body 118 that extends between an open first end 110 and an open second end 112, and defines a central chamber 120. The open first end 110 and open second end 112 are in fluidic communication by way of the central chamber 120. When assembled, a portion of the strainer 106 can extend into the central flow chamber 144 defined by the central portion 132.

The strainer 106 additionally includes the plurality of flow openings 234 that allow for fluid to freely enter and exit the central chamber 120 such that the strainer does not inhibit the flow of fluid through the Y-strainer 100 while capturing debris (larger than the diameter of the plurality of flow openings 234) in the central chamber 120, preventing it from continuing to flow with the fluid. The plurality of flow openings 234 can be hexagonal, circular, oval, or the like, in shape. The size of the plurality of flow openings 234 are dimensioned such that it stops and collects debris of a size that interferes with the operation of the piping system. The plurality of flow openings 234 may cover 40% of a surface area of the strainer 106. However, the plurality of flow openings 234 may cover the surface area of the strainer 106 between 20% and 70% as desired. The plurality of flow openings 234 may be provided on the full length of the strainer 106 from the first end 110 to the second end 112. However, it should be understood that the plurality of flow openings 234 need not be provided on the full length of the strainer 106, but may be provided on a reduced portion or a partial length from the first end 110 and the second end 112. The length from the first end 110 along which the plurality of flow openings 234 are placed may be the same length or a different length as the length from the second end 112. Additionally, the plurality of flow openings 234 may be arranged in different patterns, which can be custom designed. The strainer 106 can be fabricated by forming the plurality of flow openings 234 in a solid tube via punching, machining, laser cutting, water jet cutting, etc. The plurality of flow openings 234 can be fabricated with various sizes depending on the end-user's need for particle straining.

As previously noted in connection with FIGS. 11A-11E, the first retainer end cap 104 and second retainer end cap 108 are configured to be connected to the first end 110 and the second end 112, respectively, of the strainer 106 through a spin welding process in order to form a strainer subassembly 124, which is shown in FIGS. 13A-13C. In this regard, the first end 110 of the strainer 106 can be inserted into the annular pocket 226 of the first retainer end cap 104 while the second end 112 of the strainer 106 can be inserted into the annular pocket 226 of the second retainer end cap 108, and the radially spaced pockets 228 can be utilized to spin weld the first and second retainer end caps 104, 108 to the strainer 106. It is additionally noted that the first and second retainer end caps 104, 108 can be connected to the strainer 106 by methods other than spin welding, e.g., via solvent cement, a threaded connection, ultrasonic welding, or other mechanical attachment means. When the strainer 106 becomes full with debris, the strainer insert subassembly 126 can be removed from the barrel leg 134 to empty the strainer 106 and re-inserted into the barrel leg 134 as described below.

Notwithstanding the foregoing, the strainer subassembly 124 can be fabricated, e.g., molded, as a single unit that includes both retainer end caps 104, 108 and a solid cylindrical wall extending therebetween that is ready to be perforated with the plurality of flow openings 234, as opposed to separate components.

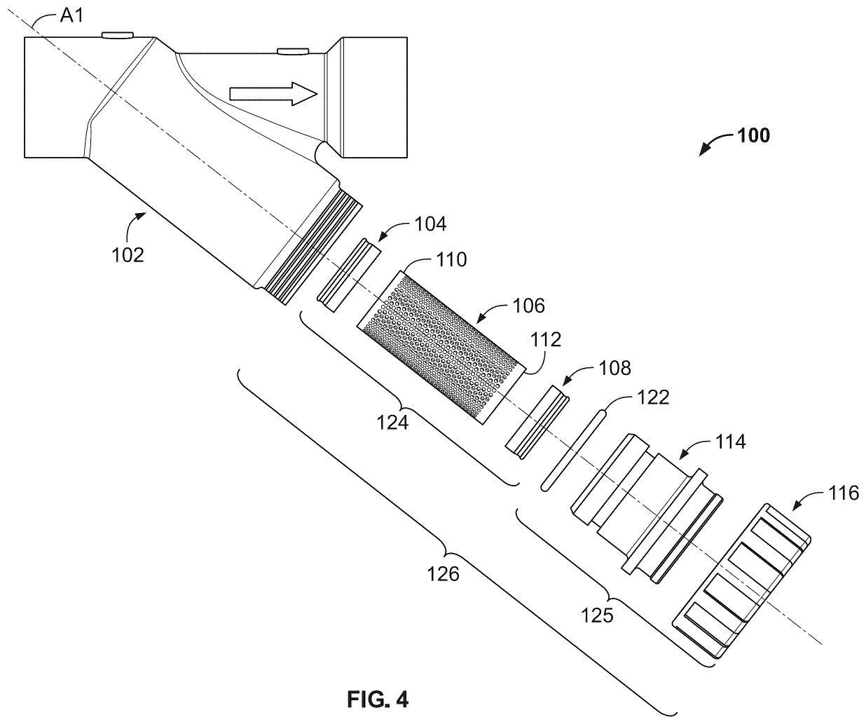

The Y-strainer 100 is assembled by first assembling the strainer insert subassembly 126, which is shown in greater detail in FIGS. 14A-14C and in the exploded view of FIG. 4. In particular, first the strainer subassembly 124 is formed by inserting the first end 110 of the strainer 106 into the annular pocket 226 of the first retainer end cap 104, affixing the first retainer end cap 104 to the strainer 106 (e.g., by spin welding), inserting the second end 112 of the strainer into the annular pocket 226 of the second retainer end cap 108, and affixing the second retainer end cap 108 to the strainer 106 (e.g., by spin welding). Next, the retainer-barrel nut subassembly 125 is formed (see FIGS. 10A-10C) by engaging the retainer 114 and the barrel nut 116. In particular, the barrel nut 116 can be placed over the retainer 114 such that the chamfered wall 210 surrounds and engages the first annular shoulder 172 of the retainer 114. Pressure can be continuously applied to the barrel nut 116 and the retainer 114 to cause the first annular shoulder 172 to continue to progress along the chamfered wall 210, which acts as a cam ramp, and towards the top opening 206 until the chamfered wall 210 snaps over the first annular shoulder 172 and into the annular channel 176 of the retainer 114 where it is retained. The retainer seal 122 is then installed in the circumferential channel 180 of the retainer 114. When the barrel nut 116 is attached to the retainer 114, and the retainer-barrel nut subassembly 125 is formed, the chamfered wall 210 is permitted to rotate freely within the annular channel 176 such that the barrel nut 116 can rotate freely about the retainer 114.

The strainer subassembly 124 is then snapped into connection with the retainer-barrel nut subassembly 125. In particular, the second retainer end cap 108 of the strainer subassembly 124 is inserted into the opening 184 of the retainer 114 and then force is applied to the strainer subassembly 124 to insert the second retainer end cap 108 into the opening 184 of the retainer 114 and force the second retainer end cap 108 over the annular ridge 194 of the retainer 114 until the second retainer end cap 108 engages the internal radial shoulder 192 of the retainer 114 with the annular ridge 194 engaged with the exterior circumferential indentation 230 of the second retainer end cap 108, as shown in FIG. 14C. Alternatively, the second retainer end cap 108 and the retainer 114 can be connected by other means, such as via threads, a twist lock connection, a lug and groove connection, a pressure-fit connection, or other mechanical engagement means, as previously noted. For example, as shown in FIG. 14D, the retainer end caps 104, 108 can each include an exterior circumferential channel 233 that receive a gasket 231. In this configuration, the second retainer end cap 108 could sealingly engage the retainer 114 and be secured thereto with a pressure-fit arrangement, e.g., with the gasket 231 positioned within the exterior circumferential channel 233 and compressed between the first inner cylindrical wall 190 of the retainer 114 and the second retainer end cap 108.

The strainer insert subassembly 126 is then inserted into the central chamber 156 of the barrel leg 134 through the opening 154. The barrel nut 116, which is free to rotate about the retainer 114, is then threadedly engaged with the external threads 162 on the open end 152 of the barrel leg 134. Continued rotation of the barrel nut 116 is performed to cause the strainer insert subassembly 126 to be further inserted into the barrel leg 134 until the bottom of the second annular shoulder 174 contacts the open end 152 of the barrel leg 134 and the first retainer end cap 104 is fully seated in the fourth bore 158d of the barrel leg 134. In this regard, since the bottom of the second annular shoulder 174 contacts the open end 152 of the barrel leg 134, the thickness of the second annular shoulder 174 and location thereof on the retainer 114 controls the seating and placement of the Y-strainer 100 components within the barrel leg 134. That is, the thickness and placement of the second annular shoulder 174 controls how deep into the barrel leg 134 the Y-strainer 100 components, e.g., the strainer subassembly 124 and the retainer seal 122, are driven, as well as the placement of those components within the barrel leg 134. Moreover, since the barrel nut 116 is permitted to rotate freely about the retainer 114, the strainer subassembly 124, the retainer 114, and the retainer seal 122 do not rotate with the barrel nut 116 and therefore are driven into the barrel leg 134 without rotating during assembly of the Y-strainer 100, which maintains the integrity of the retainer seal 122.

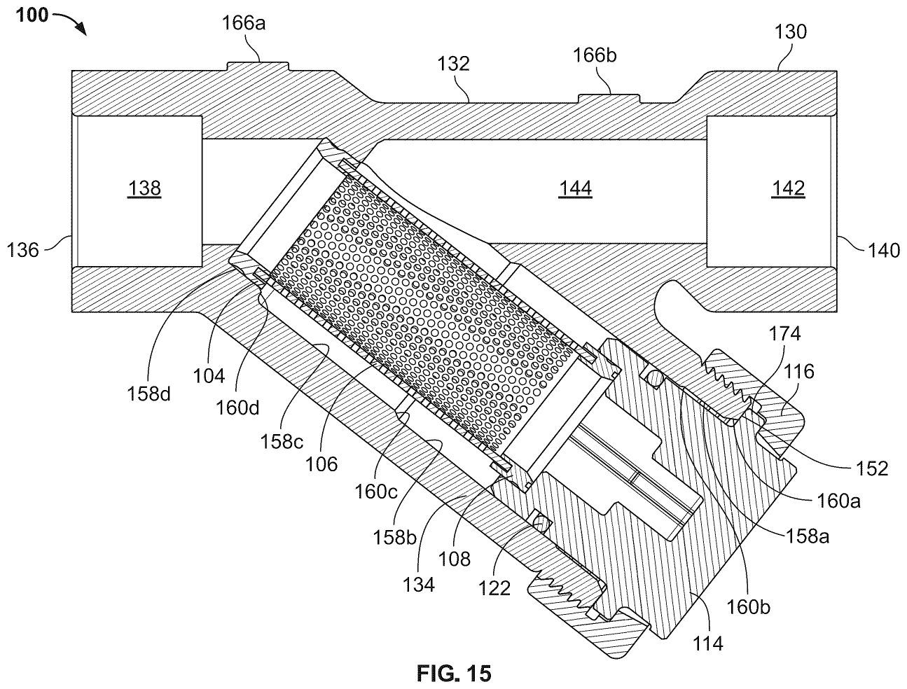

The resulting fully assembled Y-strainer 100 is shown in FIG. 15, which is a sectional view of the Y-strainer 100 of FIGS. 1-4 taken along line 15-15 of FIG. 3. As can be seen in FIG. 15, when the Y-strainer 100 is fully assembled, the retainer seal 122 is compressed and creates a seal between the body 168 of the retainer 114 and the inner surface of the second bore 158b of the barrel leg 134. The Y-strainer 100 can then be installed in a piping system of the designated size. Generally, when the Y-strainer 100 is installed in the piping system, the barrel leg 134 of the body 102 should be installed in the downward position, e.g., below the piping. This installment position allows for debris to be forced into the strainer by force applied by the fluid and by gravity. Moreover, if the Y-strainer 100 includes true union end connections, such as in FIG. 6, then an o-ring or other gasket can be installed in the front face 148 of each of the inlet and outlet ports 128, 130 prior to installation and true union nuts can be engaged with the threads 146 of the inlet and outlet ports 128, 130 of the body 102 to install the Y-strainer 100 in the piping system. The Y-strainer 100 can be operated after it is installed in a piping system. Once forward flow in the piping system is started, e.g., due to the activation of a pump in the piping system, fluid enters the Y-strainer 100 through the inlet opening 136 of the inlet port 128 of the body 102. Fluid then flows into the strainer 106 located in the barrel leg 134 of the body 102. Fluid travels through the plurality of flow openings 234 of the strainer 106 and into the central flow chamber 144. As the fluid flows through the plurality of flow openings 234, any debris/particles in the fluid that are larger than the plurality of flow openings 234 is collected in the barrel leg 134 of the body 102, as well as in the retainer 114. The fluid continues into the outlet flow chamber 142 and exits the Y-strainer 100 through the outlet opening 140 at which point it enters the external piping system to which the Y-strainer 100 is installed.

After the pump is shutdown and flow through the piping system ceases, a user can remove the strainer insert subassembly 126 to remove the debris, clean the strainer 106, and/or replace components of the strainer insert subassembly 126. To do so, a user can slowly unscrew or unfasten the barrel nut 116, which causes the barrel nut 116 to draw the entire strainer insert subassembly 126 toward the open end 152 of the barrel leg 134, e.g., due to the permanent engagement between the barrel nut 116 and the retainer 114. This process is shown in FIG. 16, which is a sectional view of the Y-strainer 100 showing the removal of components from the body 102 and the formation of a pressure relief passage 290.

As the strainer insert subassembly 126 is pulled toward the open end 152 of the barrel leg 134 and backed-out, the retainer seal 122, which is a piston-type seal that is initially engaged with the wall of the second bore 158b, moves with the retainer 114 from the second bore 158b into the first bore 158a traversing the second chamfer 160b, which has a larger diameter than the second bore 158b. Accordingly, the retainer seal 122 does not form a seal with the first bore 158a, as it did with the second bore 158b, which creates a small passage 290 between the retainer 114 and the wall of the first bore 158a of the barrel leg 134, as shown in FIG. 16. Pressure can be relieved from the barrel leg 134 and the Y-strainer 100 along the foregoing passage 290 to prevent the strainer insert subassembly 126 from being rapidly discharged from the barrel leg 134 during disassembly of the Y-strainer 100 and removal of the strainer insert subassembly 126. Notably, the length of the threads 162 on the open end 152 of the barrel leg 134 and the internal threads 214 of the barrel nut 116 are longer than the distance between the retainer seal 122 and the second chamfer 160b when the strainer insert subassembly 126 is fully inserted into the barrel leg 134 and installed. This geometry and these dimensions ensure that the barrel nut 116 remains engaged with the open end 152 of the barrel leg 134, e.g., due to the mating threads 162, 214, when the retainer seal 122 traverses the second chamfer 160b and the pressure relief passage 290 is formed, thus allowing the pressure to be relieved from the Y-strainer 100 while the barrel nut 116 is still engaged with the barrel leg 134 and ensuring the safety of the user. Once the pressure is fully relieved, the barrel nut 116 can be further rotated until it disengages the barrel leg 134 and the strainer insert subassembly 126 can be removed from the barrel leg 134.

Alternatively, the retainer seal 122 can be positioned and sized such that it initially engages the wall of the first bore 158a, as opposed to the wall of the second bore 158b, and forms a seal between the first bore 158a and the retainer 114. In this configuration, the pressure relief passage 290 is formed between the retainer 114 and the wall of the first bore 158a of the barrel leg 134 or the first chamfer 160a at the open end 152 of the barrel leg 134 as the strainer insert subassembly 126 is pulled toward the open end 152 of the barrel leg 134 and backed-out therefrom. In particular, in this configuration, the pressure relief passage 290 would be formed as the retainer seal 122 traverses the first chamfer 160a and exits the open end 152 of the barrel leg 134, e.g., as the retainer seal 122 is pulled to atmosphere. As the pressure relief passage 290 is formed, the internal threads 214 of the barrel nut 116 remain engaged with the threads 162 at the open end 152 of the barrel leg 134, thus allowing the pressure to be relieved from the Y-strainer 100 while the barrel nut 116 is still engaged with the barrel leg 134.

In another aspect, the first and second bores 158a, 158b could be combined into a single bore having the diameter of the second bore 158b. That is, the first bore 158a and the second chamfer 160b could be omitted such that the second bore 158b extends from the first chamfer 160a at the open end 152 of the barrel leg 134 to the third chamfer 160c. In this configuration, the pressure relief passage 290 is formed between the retainer 114 and the wall of the second bore 158b of the barrel leg 134 or the first chamfer 160a at the open end 152 of the barrel leg 134 as the strainer insert subassembly 126 is pulled toward the open end 152 of the barrel leg 134 and backed-out therefrom, e.g., as the retainer seal 122 is pulled to atmosphere. In particular, in this configuration, the pressure relief passage 290 would be formed as the retainer seal 122 traverses the first chamfer 160a and exits the open end 152 of the barrel leg 134. As the pressure relief passage 290 is formed, the internal threads 214 of the barrel nut 116 remain engaged with the threads 162 at the open end 152 of the barrel leg 134, thus allowing the pressure to be relieved from the Y-strainer 100 while the barrel nut 116 is still engaged with the barrel leg 134.

In still another aspect, the retainer seal 122 could be provided as a face seal that is compressed between the open end 152 of the barrel leg 134 and the bottom of the second annular shoulder 174. In this configuration, the pressure relief passage 290 is formed between the retainer 114 and the open end 152 of the barrel leg 134 as the strainer insert subassembly 126 is pulled toward the open end 152 of the barrel leg 134 and backed-out therefrom. In particular, in this configuration, the pressure relief passage 290 would be formed as soon as the barrel nut 116 is loosened and the seal between the retainer seal 122, the open end 152, and the annular shoulder 174 is broken. As the pressure relief passage 290 is formed, the internal threads 214 of the barrel nut 116 remain engaged with the threads 162 at the open end 152 of the barrel leg 134, thus allowing the pressure to be relieved from the Y-strainer 100 while the barrel nut 116 is still engaged with the barrel leg 134.

In some embodiments, all or some of the components of the Y-strainer 100 can be fabricated from, e.g., polyvinyl chloride (PVC), chlorinated polyvinyl chloride (CPVC), glass-filled polypropylene (GFPP), polyvinylidene fluoride (PVDF), and the like. However, the design of the Y-strainer 100 discussed herein should not be limited to the field of thermoplastics and can be adapted to products constructed from metal or other materials. For example, some components can be fabricated from an elastomeric material, e.g., an ethylene propylene diene monomer (EPDM), a fluoropolymer elastomer (FPM), a nitrile rubber (NBR), materials with resiliency of elastomers, materials with more or less resiliency than elastomers, and the like.

Having thus described the system and method in detail, it is to be understood that the foregoing description is not intended to limit the spirit or scope thereof. It will be understood that the embodiments of the present disclosure described herein are merely exemplary and that a person skilled in the art may make any variations and modification without departing from the spirit and scope of the disclosure. All such variations and modifications, including those discussed above, are intended to be included within the scope of the disclosure.

What is claimed is:

1. A Y-strainer device for installation in a piping system, comprising:
a body having an inlet port, an outlet port, a central portion extending between the inlet port and the outlet port, and a barrel leg, the central portion defining a first chamber placing the inlet port in fluidic communication with the outlet port and the barrel leg defining a second chamber that is in fluidic communication with the first chamber;
a nut removably fastened to a distal end of the barrel leg;
a retainer coupled to the nut and positioned within the second chamber defined by the barrel leg;
a strainer engaged with the retainer and positioned within the second chamber defined by the barrel leg, the strainer being configured to strain debris and particles from a fluid flowing through the body; and
a retainer seal, the retainer seal forming a seal between the retainer and the barrel leg when the retainer is positioned within the second chamber defined by the barrel leg,
wherein the barrel leg interconnects with the central portion at an angle.

2. The Y-strainer device of claim 1, wherein the angle is an acute angle.

3. The Y-strainer device of claim 1, wherein at least a portion of the strainer extends into the first chamber defined by the central portion.

4. The Y-strainer device of claim 1, wherein the body includes a fillet between the barrel leg and the outlet port or the barrel leg and the central portion.

5. The Y-strainer device of claim 1, wherein the barrel leg includes an open end in fluidic communication with the second chamber defined by the barrel leg and threads on an exterior of the open end, and
wherein the nut includes interior threads configured to engage the threads on the exterior of the open end of the barrel leg.

6. The Y-strainer device of claim 5, wherein the exterior threads of the barrel leg are configured to expand into the interior threads of the nut when there is a surge of pressure in the barrel leg.

7. The Y-strainer device of claim 6, wherein the exterior threads and the interior threads are buttress threads.

8. The Y-strainer device of claim 1, comprising a retainer end cap connected to an end of the strainer,
wherein the retainer end cap interconnects the strainer with the retainer and the strainer is engaged with the retainer through the retainer end cap.

9. The Y-strainer device of claim 8, wherein the retainer end cap is removably engaged with the retainer.

10. The Y-strainer device of claim 9, wherein the retainer end cap is removably engaged with the retainer with a snap-fit connection.

11. The Y-strainer device of claim 1, comprising:
a first retainer end cap connected to a first end of the strainer; and
a second retainer end cap connected to a second end of the strainer.

12. The Y-strainer device of claim 11, wherein the first retainer end cap is connected to the first end of the strainer by spin welding, and the second retainer end cap is connected to the second end of the strainer by spin welding.

13. The Y-strainer device of claim 11, wherein the first retainer end cap, the strainer, and the second retainer end cap are molded as a single component.

14. The Y-strainer device of claim 11, wherein the first retainer end cap is removably engaged with the retainer.

15. The Y-strainer device of claim 14, wherein the first retainer end cap is removably engaged with the retainer with a snap-fit connection.

16. The Y-strainer device of claim 1, wherein the strainer includes a hollow cylindrical body and a plurality of flow openings extending through the hollow cylindrical body.

17. The Y-strainer device of claim 16, wherein the plurality of flow openings are formed by laser cutting and/or by a mechanical perforating machine.

18. The Y-strainer device of claim 1, wherein unfastening of the nut causes the retainer, the strainer, and the retainer seal to be drawn out from the second chamber defined by the barrel leg, and a pressure relief passage to be formed.

19. The Y-strainer device of claim 1, wherein unfastening of the nut causes the seal between the retainer and the barrel leg formed by the retainer seal to be broken and a pressure relief passage to be formed.

20. The Y-strainer device of claim 19, wherein the retainer seal is a piston seal or a face seal.

21. The Y-strainer device of claim 1, wherein the barrel leg includes a first bore, a second bore, and a chamfer between the first bore and the second bore,
wherein the retainer seal forms a seal between the retainer and the second bore.

22. The Y-strainer device of claim 21, wherein unfastening of the nut causes the retainer, the strainer, and the retainer seal to be drawn out from the second chamber defined by the barrel leg.

23. The Y-strainer device of claim 22, wherein the retainer seal traverses the chamfer when the nut is unfastened and the retainer, the strainer, and the retainer seal are drawn out from the second chamber defined by the barrel leg, and a passage is formed between the retainer seal and the first bore when the retainer seal traverses the chamfer, the passage allowing pressure within the barrel leg to be relieved therethrough.

24. The Y-strainer device of claim 23, wherein the nut remains fastened to the distal end of the barrel as the retainer seal traverses the chamfer and the passage is formed.

25. The Y-strainer device of claim 1, wherein the retainer seal is a piston seal, and the distal end of the barrel leg is isolated from pressure within the second chamber defined by the barrel leg by the retainer seal.

26. The Y-strainer device of claim 1, wherein the nut, the retainer, the strainer, and the retainer seal are removable from the barrel leg as a single unit.

27. The Y-strainer device of claim 1, wherein the retainer includes a counter-bore defining an internal chamber that collects debris and particles strained by the strainer.

28. The Y-strainer device of claim 1, wherein the retainer includes first and second annular shoulders defining an annular channel therebetween, the annular channel configured to receive a portion of the nut and permanently connect the nut and the retainer.

29. The Y-strainer device of claim 28, wherein the nut includes a top opening and a chamfered wall about the top opening, and
wherein the nut and the retainer are permanently connected by engaging the chamfered wall with the first annular shoulder of the retainer and forcing the first annular shoulder through the top opening causing the chamfered wall to snap over the first annular shoulder and into the annular channel.

30. The Y-strainer device of claim 29, wherein the nut is capable of rotating freely about the retainer.

31. The Y-strainer device of claim 1, wherein the body includes a first tapped hole upstream of the strainer and a second tapped hole downstream of the strainer, the first and second tapped holes being configured to each receive a pressure sensing device to measure differential pressure across the strainer.

32. The Y-strainer device of claim 1, comprising a mesh element positioned on an inside of the strainer, the mesh element configured to strain particles of smaller size than the particles strained by the plurality of flow openings.

33. The Y-strainer device of claim 1, wherein the seal formed by the retainer seal is between the retainer and an interior wall of the barrel leg.

34. The Y-strainer device of claim 1, wherein the retainer seal is a piston seal or a face seal.
